(19) United States
(12) Patent Application Publication
(10) Pub. No.: US 2016/0105122 A1
(43) Pub. Date: Apr. 14, 2016

(54) SYNCHRONOUS RECTIFICATION CONTROLLER AND POWER CONVERTER USING THE SAME

(71) Applicant: SAMSUNG ELECTRO-MECHANICS CO., LTD., Suwon-si (KR)

(72) Inventors: Jung Chul GONG, Seoul (KR); Hwan CHO, Goyang-si (KR); Ho Joon JANG, Seoul (KR)

(73) Assignee: SAMSUNG ELECTRO-MECHANICS CO., LTD., Suwon-si (KR)

(21) Appl. No.: 14/818,937

(22) Filed: Aug. 5, 2015

(30) Foreign Application Priority Data
Oct. 10, 2014 (KR) 10-2014-0136822

(51) Int. Cl. H02M 3/335; H02M 7/217

(52) U.S. Cl. CPC H02M 3/33592; H02M 7/217

(57) ABSTRACT

A synchronous rectification controller and a power converter using the same may prevent malfunction at the time of an initial operation. The synchronous rectification controller may include a sensing unit sensing a magnitude of a driving current, and a driving unit outputting a rectification control signal which controls an operation of the rectification unit by the driving current sensed by the sensing unit. A flow of the driving current in the rectification unit may be selectively cut off, depending on a magnitude of a driving voltage of the synchronous rectification controller.

### CROSS-REFERENCE TO RELATED APPLICATION

This application claims the foreign priority benefit under 35 U.S.C. Section 119 of Korean Patent Application No. 10-2014-0136822, entitled “Synchronous Rectification Controller And Power Converter Using The Same” filed on Oct. 10, 2014, which is hereby incorporated by reference in its entirety into this application.

### BACKGROUND

Some embodiments of the present disclosure may relate to a synchronous rectification controller and a power converter using the same.

A converter rectification scheme may be classified into a diode rectification scheme using a diode and a synchronous rectifier scheme using, for example, but not limited to, a semiconductor switch, and the like. Recently, to reduce power consumption of communication devices, electronic devices, and the like, low-voltage and large-current output characteristics may be needed.

Some synchronous rectifiers may not be applied with power at the time of initial driving and therefore rectification may not be performed, such that a power device or converter may malfunction and electronic devices having such a power device or converter using the synchronous rectifier may have malfunction.

### SUMMARY

Some embodiments of the present disclosure may provide a synchronous rectification controller and a power converter using the same capable of preventing malfunction at the time of an initial operation.

According to an exemplary embodiment of the present disclosure, a synchronous rectification controller may include: a sensing unit sensing a magnitude of a driving current; and a driving unit outputting a rectification control signal which may control an operation of the rectification unit by the driving current sensed by the sensing unit. A flow of the driving current in the rectification unit may be selectively cut off, depending on or responding to a magnitude of a driving voltage of the synchronous rectification controller.

According to another exemplary embodiment of the present disclosure, a power device or converter may include: a power supply unit generating a driving current; a control unit controlling the power supply unit by a control signal to control a magnitude of the driving current; a rectification unit rectifying the driving current; and a synchronous rectification control unit controlling the rectification unit to output a rectification control signal. The synchronous rectification control unit may cut off a flow of the driving current in the rectification unit, depending on or responding to a magnitude of a driving voltage of the synchronous rectification control unit.

According to still another exemplary embodiment of the present disclosure, a synchronous rectification method may include the steps of: receiving a driving voltage of the synchronous rectification controller; and cutting off a flow of the driving current in the rectification unit using a voltage corresponding to the driving current when a magnitude of the driving voltage is equal to or less than a predetermined value.

### BRIEF DESCRIPTION OF DRAWINGS

FIG. 1 is a structural diagram illustrating a synchronous rectification controller according to an exemplary embodiment of the present disclosure.

FIG. 2 is a block diagram illustrating a power device converter according to an exemplary embodiment of the present disclosure.

FIG. 3 is a circuit diagram illustrating an exemplary embodiment of the power device or converter illustrated in FIG. 1.

FIG. 4 is a timing diagram illustrating an operation of the power device or converter at the time of malfunction.

FIG. 5 is a timing diagram illustrating an operation of the power device or converter illustrated in FIG. 3 at the time of initial driving.

FIG. 6 is a timing diagram illustrating an operation of the power device or converter illustrated in FIG. 3 at the time of normal driving.

FIG. 7 is a flow chart illustrating a synchronous rectification method for rectifying a driving current using a synchronous rectification controller according to an exemplary embodiment of the present disclosure.

### DESCRIPTION OF EMBODIMENTS

The acting effects and technical configuration with respect to the objects of a synchronous rectification controller and a power converter using the same according to the present disclosure will be clearly understood by the following detailed description in which exemplary embodiments of the present disclosure are described with reference to the accompanying drawings.

Further, when it is determined that the detailed description of the known art related to the present disclosure may obscure the gist of the present disclosure, the detailed description thereof will be omitted. In the present specification, the terms first, second, and so on are used to distinguish one element from another element, and the elements are not defined by the above terms.

Exemplary embodiments of the present disclosure will be described in detail with reference to the accompanying drawings illustrating an example of specific exemplary embodiments which may be practiced by the present invention. These embodiments will be described in detail for those skilled in the art in order to practice the present disclosure. It should be appreciated that various exemplary embodiments of the present disclosure are different from each other, but do not have to be exclusive. For example, specific shapes, structures, and characteristics described in the present specification may be implemented in another exemplary embodiment without departing from the spirit and the scope of the present disclosure in connection with an exemplary embodiment. In addition, it should be understood that a position or an arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings in various aspects.

Hereinafter, embodiments of the present disclosure will be described in detail with reference to the accompanying drawings so that those skilled in the art may easily practice the present disclosure.

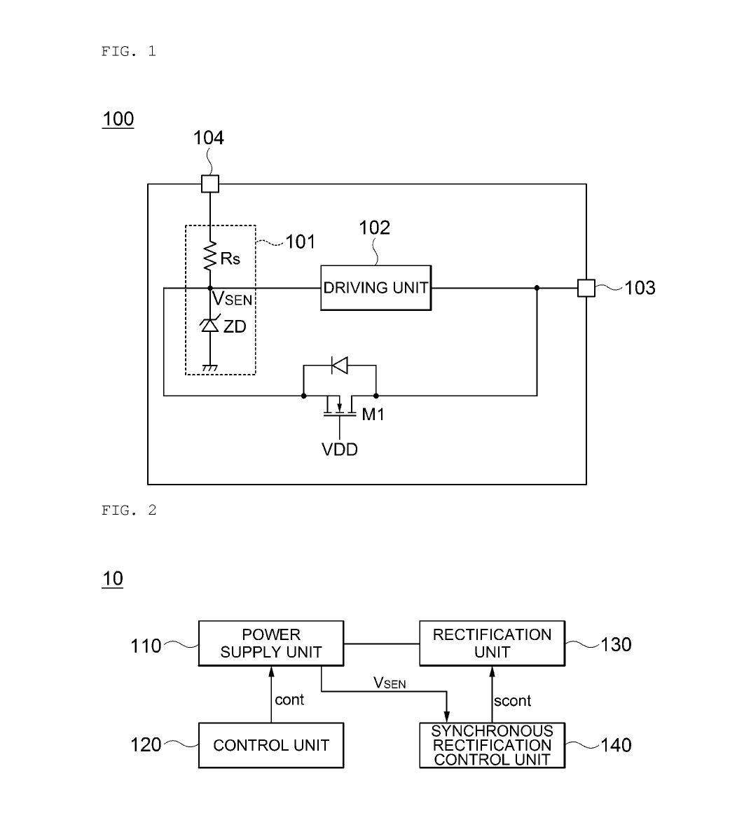

FIG. 1 is a structural diagram illustrating a synchronous rectification controller according to an exemplary embodiment of the present disclosure.

Referring to FIG. 1, a synchronous rectification controller 100 may control an operation of a rectification unit (not illustrated) which rectifies a driving current. The synchronous rectification controller 100 may include a sensing unit 101 and a driving unit 102. The sensing unit 101 may sense a magnitude of the driving current. The driving unit 102 may output a rectification control signal which controls an operation of the rectification unit based on the driving current sensed by the sensing unit 101.

The driving unit 102 may output the rectification control signal to enable the rectification unit to rectify the driving current. The sensing unit 101 may sense the driving current and transfer or output a voltage corresponding to the magnitude of the sensed driving current to the driving unit 102 to control the rectification control signal output from the driving unit 102. The sensing unit 101 may include a sensing resistor Rs and transfer or output a voltage V_{SEN}, generated by making the driving current flowing in the sensing resistor Rs, to the driving unit 102 to output the rectification control signal. In this case, when a magnitude of the current flowing in the sensing unit 101 is very large, the driving unit 102 may be damaged. To prevent the damage, the sensing unit 101 may clamp the voltage V_{SEN} corresponding to the driving current generated in the sensing resistor Rs. The sensing unit 101 may include a zener diode (ZD) to clamp the voltage V_{SEN}. The rectification control signal may be controlled by controlling a pulse width and/or a frequency of the rectification control signal. As described above, the synchronous rectification controller 100 including the driving unit 102 may be operated by receiving a driving voltage VDD. In this case, when a magnitude of the driving voltage VDD is smaller than a preset value, the driving unit 102 may not output the rectification control signal. When the driving unit does not output the rectification control signal, the rectification unit may have malfunction. To solve this problem, the synchronous rectification controller 100 may cut off the flow of the driving current in the rectification unit depending on the magnitude of the driving voltage VDD. For example, when the magnitude of the driving voltage VDD is smaller than a preset value, the flow of the driving current in the rectification unit may be cut off. Further, at the time of the initial driving of the synchronous rectification controller 100, the driving voltage VDD may not be transferred, and at the time of a normal operation of the synchronous rectification controller 100, the driving voltage VDD may be transferred. It is possible to determine whether the driving of the synchronous rectification controller 100 is in an initial state by using the preset value. The synchronous rectification controller 100 may include a switch M1. The switch M1 may be connected between the sensing unit 101 and an output terminal of the driving unit 102. The switch M1 may be turned on or off depending on the magnitude of the driving voltage VDD. For instance, when the magnitude of the driving voltage VDD is smaller than the preset value, the switch M1 may keep a turn on state, and when the magnitude of the driving voltage VDD is larger than the preset value, the switch M1 may be turned off. However, the operation of the switch M1 is not limited thereto and therefore the switch M1 may keep the turn on state regardless or independent of the magnitude of the driving voltage. When the magnitude of the driving voltage VDD is smaller than the preset value and thus the switch M1 is turned on, the output terminal of the driving unit 102 may be connected to the sensing unit 101 and a voltage from the output terminal of the driving unit 102 may be pulled-down by the voltage of the sensing unit 101 to reduce the voltage from the output terminal, thereby preventing the rectification unit from being operated. In this case, the switch M1 may be, for example, but not limited to, a MOS transistor (MOSFET), a field effect transistor (FET), and a bipolar junction transistor (BJT).

Further, the sensing unit 101 may be connected to a first terminal 104 of the synchronous rectification controller 100 to sense the voltage V_{SEN} corresponding to the driving current, and the output terminal of the driving unit 102 may output the rectification control signal controlling the operation of the rectification unit through a second terminal 103 of the synchronous rectification controller 100.

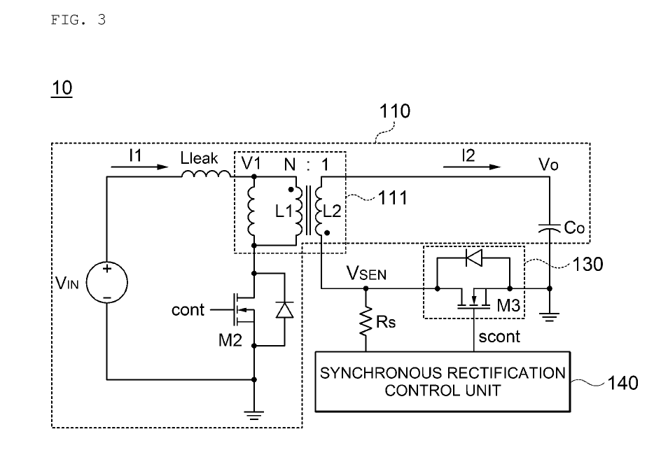

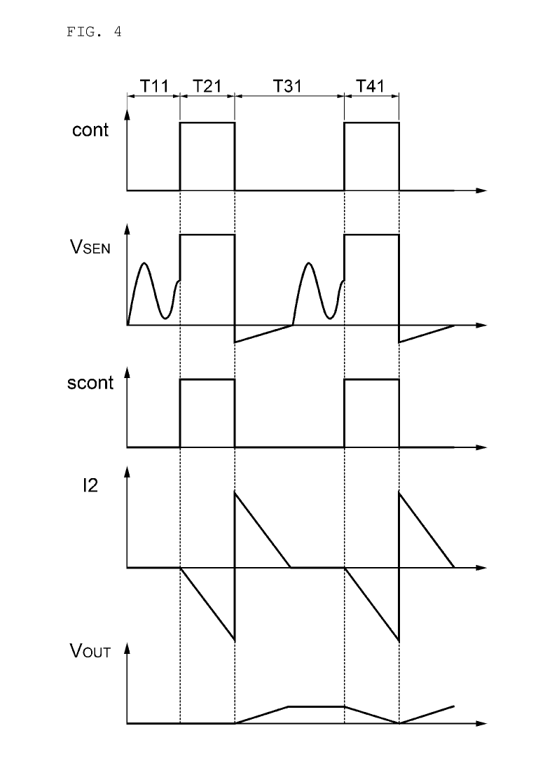

FIG. 2 is a block diagram illustrating a power converter according to an exemplary embodiment of the present disclosure, and FIG. 3 is a circuit diagram illustrating an exemplary embodiment of the power converter illustrated in FIG. 2.

Referring to FIGS. 2 and 3, a power converter 10 may include a power supply unit 110, a control unit 120, a rectification unit 130 and a synchronous rectification control unit 140. The power supply unit 110 may generate a driving current I2. The control unit 120 may control the power supply unit 110 using a control signal cont to control a magnitude of the driving current I2. The rectification unit 130 may rectify the driving current I2. The synchronous rectification control unit 140 may output a rectification control signal scont which controls the rectification unit 130. The synchronous rectification control unit 140 may cut off the flow of the driving current I2 in the rectification unit 130 depending on a magnitude of a driving voltage which drives the synchronous rectification control unit 140. In the circuit diagram of FIG. 3, the control unit 102 is not illustrated.

The power supply unit 110 may generate the driving current I2 depending on an input voltage V_{IN}. The power supply unit 110 may include a transformer 111 which may include a first winding L1 and a second winding L2. The power supply unit 110 may further include the switch M2 and may switch a current I1 flowing in the first winding L1 by a turn on or off of the switch M2. The power supply unit 110 may be, for example, but not limited to, an LLC resonance type converter. However, a kind of the power supply unit 110 is not limited thereto. The switch M2 may be, for instance, but not limited to, the MOSFET, the FET, and the BJT. The second winding L2 of the transformer 111 may generate the driving current I2 which is induced, by or depending on a change in the current I1 flowing in the first winding L1 by the switching operation of the switch M2. The magnitude of the driving current I2 induced into the second winding L2 may be controlled depending on a turn ratio of the first winding L1 to the second winding L2. Directions of the first winding L1 and the second winding L2 of the transformer 111 may be opposite to each other, and a direction of the current I1 flowing in the first winding L1 and a direction of the driving current I2 flowing in the second winding L2 may be opposite to each other.

The control unit 120 may output the control signal cont to control the turn on or off of the switch M2, and thus the magnitude of the current I1 flowing in the first winding L1 of the transformer 111 may be controlled. The turn on or off of the switch M2 may be controlled either by controlling a duty ratio which is the turn on/off ratio of the switch M2 or controlling a frequency of the control signal cont.

The rectification unit 130 may receive the driving current I2 from the power supply unit 110 to perform the switching operation so as to determine whether the operation is performed corresponding to a flow direction of the driving current I2, thereby rectifying the driving current I2. To this end, the rectification unit 130 may include a switch M3. The switch M3 may be, for example, but not limited to, a transistor. A first electrode of the transistor may be connected to the second winding L2, a second electrode of the transistor may be connected to a load, and a gate electrode of the transistor may be connected to the synchronous rectification control unit 140. A turn on or off of the transistor may be determined depending on or responding to a magnitude of a voltage applied to the gate electrode of the transistor to make the driving current selectively flow the transistor, such that the rectification unit 130 may rectify the driving current I2. In this case, the switch M3 may be, for example, but not limited to, the MOSFET, the FET, and the BJT.

The synchronous rectification control unit 140 may transfer the rectification control signal scont to the rectification unit 130 to enable the rectification unit 130 to operate the driving current I2. Here, the synchronous rectification control unit 140 may be the synchronous rectification controller 100 illustrated in FIG. 1. A first terminal of the synchronous rectification control unit 140 may be connected to the rectification unit 130 and a second terminal thereof may be connected to the power supply unit 110 to output the rectification control signal scont which controls the rectification unit 130 through the first terminal and to sense the driving current I2 flowing in the power supply unit 110 through the second terminal. Further, the synchronous rectification control unit 140 may output the rectification control signal scont depending on the sensed driving current I2, thereby driving the rectification unit 130. When the switch M3 of the rectification unit 130 is a transistor, the synchronous rectification control unit 140 may transfer the rectification control signal scont to the gate electrode of the switch M3, thereby turning on or off the switch M1. In this case, when the magnitude of the driving voltage VDD which drives the synchronous rectification control unit 140 is equal to or less than a predetermined value, the synchronous rectification control unit 140 may not output the rectification control signal scont and thus the gate electrode of the switch M3 may be in a floating state, such that a parasitic capacitor (not illustrated) may be formed between the first electrode and the gate electrode of the switch M3.

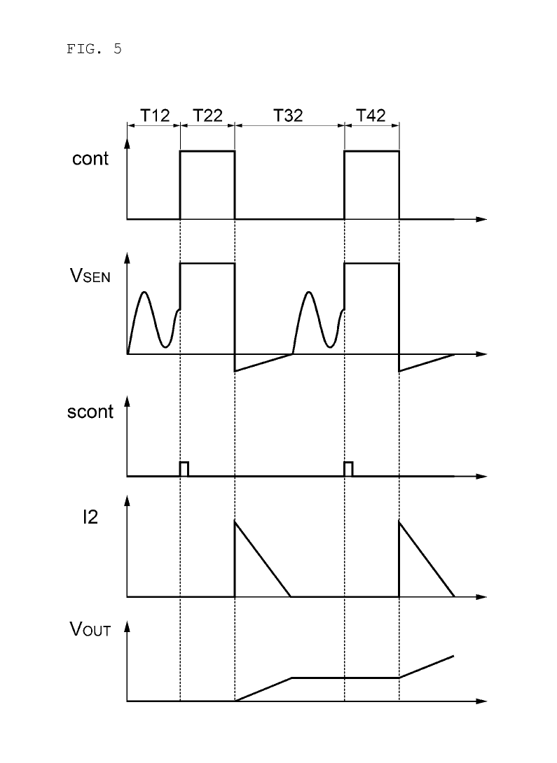

FIG. 4 is a timing diagram illustrating an operation of the power converter at the time of malfunction.

Referring to FIG. 4, the control signal cont may be input in a low state in a first section T11 and thus the switch M2 may be in a turn off state, such that it is possible to prevent a current from flowing in the first winding L1 of the transformer 111. In this case, the voltage sensed by the sensing unit 101 of the synchronous rectification control unit 140 may appear like a sine curve by resonance.

The control signal cont may be input in a high state in a second section T21 and thus the switch M2 may be in a turn on state. When the switch M2 is in the turn on state, a current may flow in the first winding L1 of the transformer 111 and thus the driving current I2 induced in the second winding L2 of the transformer 111 may flow. Further, the voltage sensed by the sensing unit 101 may be in a high state by the driving current I2. However, when the driving voltage VDD which drives the synchronous rectification control unit 140 is smaller than a predetermined value, the synchronous rectification control unit 140 may not be driven. When the synchronous rectification control unit 140 is not driven, the gate electrode of the switch M3 may be in a floating state and the parasitic capacitor may be formed between the first electrode of the switch M3 and the gate electrode of the switch M3. When the gate electrode of the switch M3 is in a floating state, the voltage of the gate electrode of the switch M3 may move or be changed depending on the voltage of the first electrode of the switch M3 and thus like the voltage sensed by the sensing unit 101, the voltage of the gate electrode of the switch M3 may keep the high state. When the voltage of the gate electrode of the switch M3 keeps the high state, the driving current I2 may flow.

When the switch M2 is turned off in a third section T31, the current I1 flowing in the first winding L1 may be cut off and thus a magnitude of electromotive force generated in the first winding L1 in the third section T31 may become opposite to a magnitude of electromotive force generated in the first winding L1 in the second section T21, such that the direction of the driving current I2 generated in the second winding L2 in the third section T31 may be opposite to a flow direction in the second section T21. In this case, since the direction of the driving current I2 in the third section T31 may be opposite to that of the driving current in the second section T21, the voltage V_{SEN} sensed by the sensing unit 101 may be a negative (−) voltage. Further, when a predetermined time elapses in the third section T31, a current direction may not be changed and thus the driving current I2 may not induced into the second winding L2, such that the voltage V_{SEN} sensed by the sensing unit 101 may again become 0V. Further, the voltage V_{SEN} sensed by the sensing unit 101 may again appear as a sine curve by the resonance.

An operation in a fourth section T41 may the same as that in the second section T21.

Therefore, even though the synchronous rectification control unit 140 is not driven, a current flows in different directions in the second section T21 and the third section T31, and therefore the rectification unit 130 may not rectify the driving current I2. Therefore, a magnitude of an output voltage V_{OUT} may not be increased.

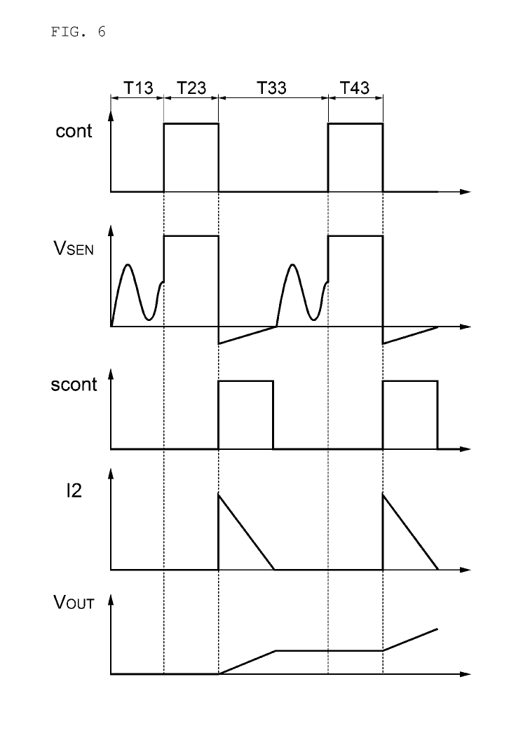

FIG. 5 is a timing diagram illustrating an operation of the power converter illustrated in FIG. 3 at the time of initial driving.

Referring to FIG. 5, the control signal cont may be input in a low state in a first section T12 and thus the switch M2 may be in a turn off state, such that it is possible to prevent a current from flowing in the first winding L1 of the transformer 111. In this case, the voltage V_{SEN} sensed by the sensing unit 101 of the synchronous rectification control unit 140 may appear like the sine curve by resonance.

The control signal cont may be input in the high state in a second section T22 and thus the switch M2 may be in the turn on state. When the switch M2 is in the turn on state, a current may flow in the first winding L1 of the transformer 111 and thus the driving current I2 induced into the second winding L2 of the transformer 111 may flow. Further, the voltage V_{SEN} sensed by the sensing unit 101 may be in the high state by the driving current I2. However, when the driving voltage VDD which drives the synchronous rectification control unit 140 is smaller than a predetermined value, the synchronous rectification control unit 140 may not be driven. When the synchronous rectification control unit 140 is not driven, the gate electrode of the switch M3 may be in the floating state and the parasitic capacitor may be formed between the first electrode of the switch M3 and the gate electrode of the switch M3. In this case, the switch M1 may be connected between the sensing unit 101 and the gate electrode of the switch M3 and the switch M1 may keep the turn on state when the driving voltage VDD which drives the synchronous rectification control unit 140 is equal to or less than the predetermined value. When the switch M1 keeps the turn on state, the voltage V_{SEN} sensed by the sensing unit 101 may be transferred to the gate electrode of the switch M3. Since the voltage V_{SEN} sensed by the sensing unit 101 may be transferred to the first electrode of the switch M3 and thus the gate electrode of the switch M3 may be in the floating state, the voltage of the gate electrode of the switch M3 may be pulled-down to prevent the switch M3 from being turned on. Therefore, the driving current I2 may not flow. In this case, the rectification control signal scont may enable a voltage lower than a threshold voltage due to a delay to instantly appear.

When the switch M1 is turned off in a third section T32, the current I1 flowing in the first winding L1 may be cut off and thus a magnitude of electromotive force generated in the first winding L1 may become opposite to that in the second section T22, such that the direction of the driving current I2 generated in the second winding L2 in the third section T32 may be opposite to a flow direction in the second section T12 of FIG. 4. In this case, since the direction of the driving current I2 in the third section T32 may be opposite to that of the driving current in the second section T21, the voltage V_{SEN} sensed by the sensing unit 101 may be a negative (−) voltage. Further, when a predetermined time elapses in the third section T32, a current direction may not be changed and thus the driving current I2 may not be induced into the second winding L2, such that the voltage V_{SEN} sensed by the sensing unit 101 may again become 0V. Further, the voltage V_{SEN} sensed by the sensing unit 101 may appear as a sine curve by the resonance.

An operation in a fourth section T42 may be the same as that in the second section T22.

Therefore, even though the synchronous rectification control unit 140 is not driven, since the current does not flow in the second section T22, the rectification unit 130 may rectify the driving current I2. Therefore, a magnitude of an output voltage Vout may be increased.

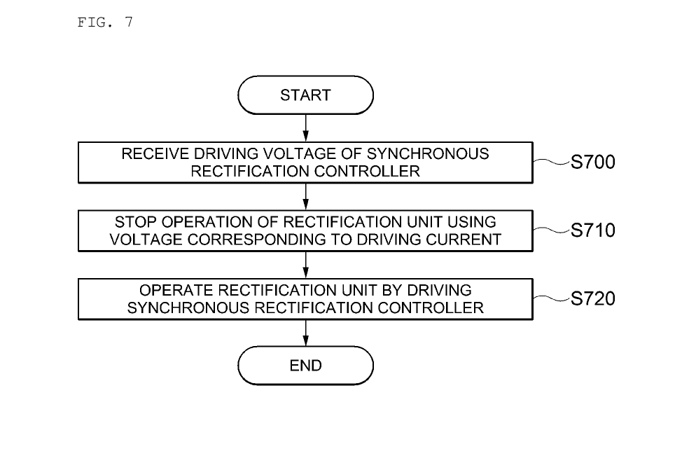

FIG. 6 is a timing diagram illustrating an operation of the power converter illustrated in FIG. 3 at the time of normal driving.

Referring to FIG. 6, the control signal cont may be input in the low state in a first section T13 and thus the switch M2 may be in the turn off state, such that it is possible to prevent a current from flowing in the first winding L1 of the transformer 111. In this case, the voltage V_{SEN} sensed by the sensing unit 101 of the synchronous rectification control unit 140 may appear like the sine curve by resonance.

The control signal cont may be input in a high state in a second section T23 and thus the switch M2 may be in the turn on state. When the switch M2 is in the turn on state, a current may flow in the first winding L1 of the transformer 111 and thus the driving current I2 induced into the second winding L2 of the transformer 111 may flow. Further, the voltage V_{SEN} sensed by the sensing unit 101 may be in the high state by the driving current I2.

When the switch M2 is turned off in a third section T33, the current I1 flowing in the first winding L1 may be cut off and thus a magnitude of electromotive force generated in the first winding L1 becomes opposite to that in the second section T23, such that the direction of the driving current I2 generated in the second winding L2 in the third section T33 may be opposite to a flow direction in the second section T23. In this case, since the direction of the driving current I2 in the third section T33 may be opposite to that of the driving current in the second section T23, the voltage V_{SEN} sensed by the sensing unit 101 may be a negative (−) voltage. Further, the synchronous rectification control unit 140 may be normally operated and thus the switch M3 may be turned on by the rectification control signal in the third section T33, such that the driving current may flow in the second winding L2. Further, when a predetermined time elapses in the third section T33, a current direction may not be changed and thus the driving current I2 may not induced into the second winding L2, such that the voltage V_{SEN} sensed by the sensing unit 101 may again be 0V. Further, the voltage V_{SEN} sensed by the sensing unit 101 may appear as a sine curve by the resonance.

An operation in a fourth section T43 may be the same as that in the second section T23.

Therefore, since the synchronous rectification control unit 140 is driven, the current may not flow in the second section T23, and thus the rectification unit 130 may rectify the driving current I2. Therefore, the magnitude of the output voltage V_{OUT} may be increased.

FIG. 7 is a flow chart illustrating a synchronous rectification method for rectifying a driving current using a synchronous rectification controller according to an exemplary embodiment of the present disclosure.

Referring to FIG. 7, the synchronous rectification method for rectifying the driving current using the synchronous rectification controller controlling the operation of the rectification unit may include the steps of receiving the driving voltage of the synchronous rectification controller (S700) and cutting off the driving current flowing in the rectification unit using the voltage corresponding to the driving current (S710). The driving voltage of the synchronous rectification controller may be equal to or less than a predetermined value at the time of initial driving. When a predetermined constant time elapses from the initial delay, the driving voltage of the synchronous rectification controller may be equal to or more than the predetermined value. When the driving voltage is equal to or less than the predetermined value, the synchronous rectification controller may not be driven, such that the rectification unit may not rectify the driving current. Therefore, when the flow of the driving current in the rectification unit is cut off responding to the driving voltage, the problem that the driving current is not rectified may be solved.

According to the exemplary embodiment of the present disclosure, the synchronous rectification method may further include the step of rectifying the driving current by driving the synchronous rectification controller to normally operate the rectification unit (S720). Therefore, according to the synchronous rectification method rectifying the driving current, at the time of the initial driving of the synchronous rectification controller or even when the synchronous rectification controller is not driven, the synchronous rectification controller may be normally operated to rectify the driving current.

Some embodiments of the synchronous rectification controller and the power converter using the same may prevent malfunction from occurring at the time of initial driving.

Function of various components illustrated in the drawings of the present disclosure may be provided by using hardware which may associated with appropriate software to run software and dedicated hardware. When provided by a processor, these functions may be provided by a single dedicated processor, a single sharing processor, or a plurality of individual processor which may share a portion thereof.

In the claims in the present specification, elements represented as a means for performing a specific function include any scheme performing the specific functions and the elements may include a combination of circuit elements performing the specific function or software in any form including firmware, microcode, and the like which are coupled with a circuit suitable to perform software for performing the specific function.

In the present specification, ‘one embodiment’ of principles of the present disclosure and names for various changes of the expression mean that specific features, structures, characteristics, and the like, associated with the embodiment are included in at least one embodiment of the principle of the present disclosure. Therefore, the expression ‘one embodiment’ and any other modification examples disclosed throughout the present specification do not necessarily mean the same embodiment.

In the present specification, ‘connected’ or ‘connecting’ and names for various modifications of these expressions are used as a meaning including ones directly connected to other components or ones indirectly connected thereto through other components. Unless explicitly described to the contrary, a singular form includes a plural form in the present specification. In addition, components, steps, operations, and elements mentioned as ‘comprise’ or ‘comprising’ in the present specification do not exclude the existence or addition of one or more other components, steps, operations, and elements, and apparatuses.

What is claimed is:

1. A synchronous rectification controller controlling a rectification unit rectifying a driving current, comprising:
a sensing unit sensing a magnitude of the driving current; and
a driving unit outputting a rectification control signal which controls the rectification unit by the driving current sensed by the sensing unit,
wherein the synchronous rectification controller selectively cuts off a flow of the driving current in the rectification unit in response to a magnitude of a driving voltage of the synchronous rectification controller.

2. The synchronous rectification controller according to claim 1, further comprising a first switch turned on or off depending on the magnitude of the driving voltage,
wherein the flow of the driving current in the rectification unit is selectively cut off in response to a turn on or off status of the first switch.

3. The synchronous rectification controller according to claim 1, wherein the sensing unit clamps a voltage corresponding to the magnitude of the driving current.

4. The synchronous rectification controller according to claim 1, wherein:
the sensing unit senses the magnitude of the driving current through a first terminal, and
the driving unit outputs the rectification control signal controlling the rectification unit through a second terminal.

5. A power device, comprising:
a power supply unit generating a driving current;
a control unit controlling the power supply unit to regulate a magnitude of the driving current;
a rectification unit rectifying the driving current; and
a synchronous rectification control unit controlling the rectification unit to output a rectification control signal,
wherein the synchronous rectification control unit selectively cuts off a flow of the driving current in the rectification unit, depending on a magnitude of a driving voltage of the synchronous rectification control unit.

6. The power device according to claim 5, wherein the synchronous rectification control unit includes a first switch turned on or off in response to the magnitude of the driving voltage, and the flow of the driving current in the rectification unit is selectively cut off in response to a turn on or off status of the first switch.

7. The power device according to claim 5, wherein the rectification unit includes a second switch switching the flow of the driving current and the rectification control signal controls the second switch to be turned on or off.

8. The power device according to claim 7, wherein the synchronous rectification control unit includes a first switch turned on or off in response to the magnitude of the driving voltage, and a turn off state of the second switch is selectively maintained in response to a turn on or off status of the first switch.

9. The power device according to claim 8, wherein the synchronous rectification control unit further includes a sensing unit sensing the magnitude of the driving current, and the first switch transfers a voltage sensed by the sensing unit to the second switch to keep the second switch be in the turn off state.

10. The power device according to claim 5, wherein the synchronous rectification control unit further includes a sensing unit sensing the magnitude of the driving current, and the sensing unit clamps a voltage corresponding to the magnitude of the driving current.

11. The power device according to claim 5, wherein:
the synchronous rectification control unit includes:
a sensing unit sensing the magnitude of the driving current through a first terminal; and
a driving unit outputting the rectification control signal controlling the rectification unit through a second terminal, and
the rectification control signal is generated by the magnitude of the driving current sensed by the sensing unit and the generated rectification control signal cuts off the flow of the driving current in the rectification unit.

12. The power device according to claim 6, wherein:
the synchronous rectification control unit includes:
a sensing unit sensing the magnitude of the driving current through a first terminal; and
a driving unit outputting the rectification control signal controlling the rectification unit through a second terminal, and
the rectification control signal is generated by the magnitude of the driving current sensed by the sensing unit and the generated rectification control signal cuts off the flow of the driving current in the rectification unit.

13. A synchronous rectification method for controlling rectifying a driving current using a synchronous rectification controller controlling a rectification unit, comprising:
receiving a driving voltage of the synchronous rectification controller; and
cutting off a flow of the driving current in the rectification unit using a voltage corresponding to the driving current when a magnitude of the driving voltage is equal to or less than a predetermined value.

14. The synchronous rectification method according to claim 13, further comprising rectifying, by the rectification unit, the driving current by driving the synchronous rectification controller by the driving voltage.
